(19) United States
(12) Patent Application Publication
(10) Pub. No.: US 2026/0287485 A1
(43) Pub. Date: Sep. 24, 2026

(54) IMPACT TEST SYSTEM CAPABLE OF ADJUSTING SAWTOOTH SHOCK DURATION, AND SYSTEM FOR MONITORING AND ENSURING SAFETY OF IMPACT TEST SYSTEM

(71) Applicant: AGENCY FOR DEFENSE DEVELOPMENT, Daejeon (KR)

(72) Inventors: HYUNMYUNG KIM, Daejeon (KR); IN KI PARK, Daejeon (KR)

(21) Appl. No.: 19/559,485

(22) Filed: Mar. 6, 2026

(30) Foreign Application Priority Data
Mar. 20, 2025 (KR) 10-2025-0036000

(51) Int. Cl. G01N 3/303

(52) U.S. Cl. CPC G01N 3/303; G01N 2203/001; G01N 2203/0204; G01N 2203/0252; G01N 2203/0635; G01N 2203/0647

(57) ABSTRACT

An impact test system capable of adjusting a sawtooth shock duration is provided. The impact test system includes a base, a test table disposed above the base at a distance from the base and capable of being dropped toward the base, a test specimen disposed on the test table, and lead cone assemblies disposed on the base, in which the lead cone assemblies include a lead cone in a cone shape and an adjustment plate disposed between the lead cone and the base, a sawtooth shock wave is generated when the test table collides with the lead cone due to a drop of the test table, and a sawtooth shock duration is adjusted by adjusting heights of the lead cone assemblies according to the adjustment plate.

### CROSS-REFERENCE TO RELATED APPLICATION

This application claims the benefit of Korean Patent Application No. 10-2025-0036000, filed on Mar. 20, 2025, in the Korean Intellectual Property Office, the entire disclosure of which is incorporated herein by reference for all purposes.

### TECHNICAL FIELD

One or more embodiments relate to an impact test system capable of adjusting a sawtooth shock duration, and a system for monitoring and ensuring the safety of the impact test system.

### BACKGROUND

A table drop-type impact test system is used to test or prove the durability of products in an impact environment during the development of munitions and commercial products. A sawtooth wave shock refers to a shock wave having the maximum acceleration and duration, in which the shock wave has the shape of a right-angled triangle. A method of implementing a sawtooth wave shock as a drop-type impact test system is to install a lead cone for generating a sawtooth wave shock between a test table and a base, and then, a sawtooth wave shock occurs when the test table collides with the lead cone. Therefore, the shape of a lead cone is an important factor when generating a sawtooth wave shock in a drop-type impact test system. Before the impact test, the shape of a lead cone is determined so that a sawtooth wave shock requested by a client may be achieved, and a verification test of the sawtooth wave shock amount is performed.

The currently operating table drop-type impact test system has four problems. First, when a test specimen is heavy, a device capable of adjusting a shock duration is required. Before the present test, the ideal test procedure is to make a dummy specimen that is the same as the present test specimen and to perform a verification test of the sawtooth wave shock amount. However, due to the nature of a system development project, it is not possible to make the dummy specimen that is the same as the present test specimen due to the business period and budget problems, so the verification test of the sawtooth wave shock amount is performed by mounting only an empty table or a test specimen fixed board (hereinafter, referred to as a fixture) on an impact tester. However, when an impact test is performed on a large and heavy test specimen under the sawtooth shock wave test conditions based on an empty table or a fixture, in the present sawtooth impact test, a phenomenon in which the shock duration is shorter than that of the preliminary test occurs. The shortening of the shock duration mainly occurs when the weight difference in the present test is 200 kilograms (kg) or more, based on the preliminary test.

Second, a system for identifying whether a lead cone is mounted is needed. In the sawtooth impact test, a sawtooth impact is generated when a test table on which a test specimen is mounted collides with a lead cone on a base. A lead cone used in the sawtooth impact test is a disposable consumable that must be replaced for each test as the lead cone permanently deforms rather than returns to its initial shape after the impact test due to the properties of lead materials. However, since there is no safety system for identifying whether a lead cone is installed on a drop impact tester and where the lead cone is installed, the impact tester continues to operate even if a deformed lead cone is removed during the test but a new lead cone is not installed or is installed in the wrong position. If the impact tester is dropped from the height of the test conditions and collides with a base while a lead cone is not installed or is not installed in the correct position, the impact tester or test specimen may be damaged.

Third, a system for accurately measuring the impact velocity of a test table of a drop impact tester and monitoring the impact velocity to improve safety is needed. A drop-type impact tester adopts a system for generating the velocity on a test table while the test table is freely dropped from a predetermined height and imparting, to a test specimen, an impact amount generated when colliding with a lead cone at the generated velocity. Therefore, accurately calculating the velocity of a dropping test table plays an important role in the precision and safety of the test. However, the current impact tester only includes a system providing an approximate drop height and does not include a system providing an exact drop velocity. While it is possible to calculate the free drop velocity according to the drop height using Newtonian mechanics, this method has a problem in that the actual collision velocity may not be predicted because the friction factor caused by a mechanical device of the drop impact tester is not reflected.

Finally, a safety system for preventing access by a tester to test equipment, incorporating artificial intelligence (AI)-based reading technology capable of identifying the tester in an image in which the test equipment is captured in real time, is needed. During the impact test, a drop-type impact tester may cause physical damage to the body of the person involved in the test due to the scattering of fragments of a test specimen caused by partial damage to the test specimen or negligence in operating the test equipment. Therefore, a safety system for preventing access by a tester to test equipment is needed when a test table is in operation or reaches a drop height. Japanese Patent Registration No. 6944727 discloses an impact test device.

### SUMMARY

Embodiments provide an impact test system capable of adjusting the sawtooth shock duration, which stacks an adjustment plate on a lead cone to eliminate the need to manufacture a dedicated lead cone considering the shape and weight of a test specimen, thereby saving the time and cost, and adjusts the sawtooth shock duration by the adjustment plate even when changes in the shape and weight of the test specimen occur.

Embodiments provide a system for monitoring and ensuring the safety of an impact test system, which monitors the number and positions of lead cone assemblies of the impact test system, monitors the impact velocity of a test table, and prevents access by a tester to the impact test system.

According to an aspect, there is provided an impact test system capable of adjusting a sawtooth shock duration including a base, a test table disposed above the base at a distance from the base and capable of being dropped toward the base, a test specimen disposed on the test table, and lead cone assemblies disposed on the base, in which the lead cone assemblies include a lead cone in a cone shape and an adjustment plate disposed between the lead cone and the base, a sawtooth shock wave is generated when the test table collides with the lead cone due to a drop of the test table, and a sawtooth shock duration is adjusted by adjusting heights of the lead cone assemblies according to the adjustment plate.

A lead cone groove may be formed in a lower surface of the lead cone, and a protruding element may be formed in an upper surface of the adjustment plate, so the lead cone and the adjustment plate are connected to one another by coupling of the lead cone groove and the protruding element.

The adjustment plate may be formed in plurality, in which a groove may be formed in a lower surface of the adjustment plate, so the plurality of adjustment plates may be connected to one another by coupling of the groove and the protruding element of the adjustment plate.

The lead cone groove of the lead cone may extend along a circumferential direction of the lower surface of the lead cone, and the protruding element and the groove of the adjustment plate may extend along circumferential directions of the upper surface and the lower surface of the adjustment plate, respectively.

A system for measuring the number and positions of the lead cone assemblies of the impact test system capable of adjusting the sawtooth shock duration may include a laser generator disposed on one side of the base and configured to generate a laser, a laser receiver disposed on another side of the base and configured to receive an output signal by the laser generated from the laser generator, and a controller configured to receive information on the number and the positions of the lead cone assemblies from the laser receiver.

The laser receiver may be configured to, in a first stage, measure whether the number of the lead cone assemblies is the same as a preset number of lead cone assemblies, and in a second stage, measure whether the positions of the lead cone assemblies are the same as preset positions of lead cone assemblies.

A system for measuring a drop velocity of the test table of the impact test system capable of adjusting the sawtooth shock duration may include a position measurement sensor configured to sense a position of the test table, a magnetic coil connected to the test table and surrounding the position measurement sensor, and a controller configured to calculate a velocity at which the test table collides with the lead cone from the position measurement sensor, in which the position measurement sensor may be configured to sense the position of the test table by movement of the magnetic coil surrounding the position measurement sensor.

The position measurement sensor may correspond to a linear variable differential transformer (LVDT).

A system for preventing access by a tester to the impact test system capable of adjusting the sawtooth shock duration may include a camera disposed around the impact test system and configured to monitor the impact test system, an image reader connected to the camera and configured to read an image monitored by the camera, and a controller configured to stop an operation of the impact test system when the image reader determines that the tester is present.

The image reader may be configured to read the image through artificial intelligence (AI).

Additional aspects of embodiments will be set forth in part in the description which follows and, in part, will be apparent from the description, or may be learned by practice of the disclosure.

According to embodiments, an impact test system capable of adjusting the sawtooth shock duration may stack an adjustment plate on a lead cone to eliminate the need to manufacture a dedicated lead cone considering the shape and weight of a test specimen, thereby saving the time and cost, and may adjust the sawtooth shock duration by the adjustment plate even when changes in the shape and weight of the test specimen occur.

According to embodiments, a system for monitoring and ensuring the safety of an impact test system may monitor the number and positions of lead cone assemblies of the impact test system, monitor the impact velocity of a test table, and prevent access by a tester to the impact test system.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 schematically illustrates a side view of an impact test system capable of adjusting a sawtooth shock duration, according to an embodiment;

FIG. 2A schematically illustrates a side view of a lead cone assembly according to an embodiment;

FIG. 2B schematically illustrates a bottom view of a lead cone according to an embodiment;

FIG. 2C schematically illustrates a top view of an adjustment plate according to an embodiment;

FIG. 2D schematically illustrates a bottom view of an adjustment plate according to an embodiment;

FIG. 3 schematically illustrates a side view of a lead cone assembly having a plurality of adjustment plates, according to an embodiment;

FIG. 4 schematically illustrates a side view of a system for measuring the number and positions of lead cone assemblies, according to an embodiment;

FIG. 5 schematically illustrates a top view of a system for measuring the number and

positions of lead cone assemblies, according to an embodiment;

FIG. 6 schematically illustrates a signal transmission system of a system for measuring the number and positions of lead cone assemblies, according to an embodiment;

FIG. 7 illustrates a schematic diagram of a system for measuring a drop velocity of a test table, according to an embodiment;

FIG. 8 illustrates a schematic diagram of a system for preventing access by a tester, according to an embodiment; and

FIG. 9 illustrates a signal transmission system of a system for preventing access by a tester, according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In the descriptions of the embodiments referring to the accompanying drawings, like reference numerals refer to like elements and any repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. Each of these terms is not used to define an essence, order, or sequence of corresponding components, but used merely to distinguish the corresponding components from other components. It is to be understood that if a component is described as being “connected,” “coupled” or “joined” to another component, the former may be directly “connected,” “coupled,” and “joined” to the latter or “connected”, “coupled”, and “joined” to the latter via another component.

Components included in an embodiment and components having a common function are described using the same names in other embodiments. Unless stated otherwise, the description of an embodiment may be applicable to other embodiments, and a repeated description related thereto is omitted.

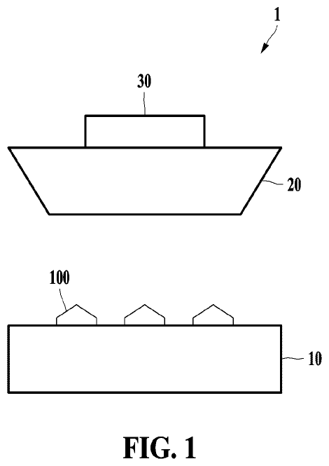

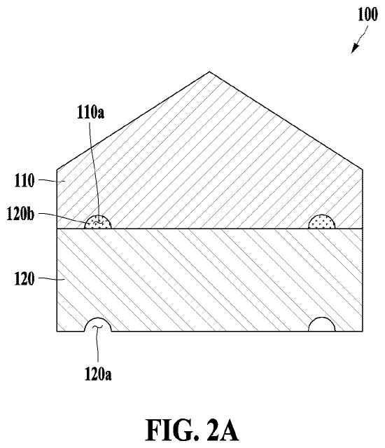

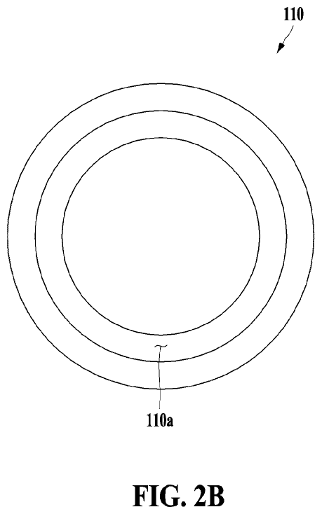

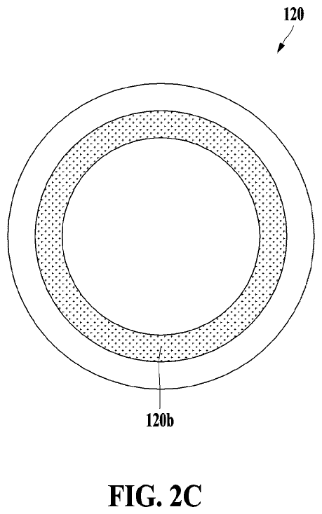

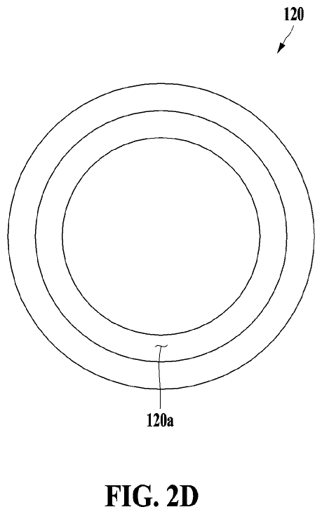

FIG. 1 schematically illustrates a side view of an impact test system 1 capable of adjusting a sawtooth shock duration, according to an embodiment. FIG. 2A schematically illustrates a side view of a lead cone assembly 100 according to an embodiment. FIG. 2B schematically illustrates a bottom view of a lead cone 110 according to an embodiment. FIG. 2C schematically illustrates a top view of an adjustment plate 120 according to an embodiment. FIG. 2D schematically illustrates a bottom view of the adjustment plate 120 according to an embodiment.

Referring to FIG. 1, the impact test system 1 capable of adjusting the sawtooth shock duration, according to an embodiment, may include a base 10, a test table 20 disposed above the base 10 at a distance from the base 10 and capable of being dropped toward the base 10, a test specimen 30 disposed on the test table 20, and the lead cone assembly 100 disposed on the base 10.

In addition, referring to FIG. 2A, the lead cone assembly 100 may include the lead cone 110 in a cone shape and the adjustment plate 120 disposed between the lead cone 110 and the base 10.

Specifically, a sawtooth shock wave may be generated when the test table 20 collides with the lead cone 110 due to the drop of the test table 20. Here, it may be preferable to use appropriate dimensions and numbers of the lead cones 110 to meet the test conditions. For example, when the weight of the test table 20 is 450 kilograms (kg), the dimensions and minimum number of uses of the lead cones 110 used to generate a sawtooth shock wave may be as shown in [Table 1] below.

TABLE 1

| Height | Diameter | Thickness | Minimum number |
|---|---|---|---|
| [mm] | [mm] | [mm] | of uses |
| 17 | 40 | 8 | 2 |
| 20 | 50 | 10 | 3 |
| 22 | 60 | 10 | 3 |
| 25 | 60 | 12 | 3 |
| 30 | 60 | 12 | 3 |
| 35 | 60 | 12 | 3 |

Furthermore, compared to the preliminary test in which the test table 20 is dropped alone, in the present test in which the test table 20 and the test specimen 30 are dropped together, a shorter time than the target shock duration may occur. Accordingly, it may be adjusted to increase the sawtooth shock duration by adjusting the height of the lead cone assembly 100 according to the adjustment plate 120. For example, when the height of the adjustment plate 120 is 2 millimeters (mm), the sawtooth shock duration may be increased by 1 millisecond (ms), and proportionally, when the height is 4 mm, the sawtooth shock duration may be increased by 2 ms.

Accordingly, the adjustment plate 120 may determine the shock duration that needs to be increased, may be selected according to the diameter of the lead cone 110 used in the preliminary test and the height according to the required increase time, and may be disposed in a lower portion of the lead cone 110.

When manufacturing a dedicated lead cone considering the characteristics (i.e., the shape and weight of the test specimen 30) of the weapon system under development, there is a problem in that the efficiency of the test is deteriorated due to the increase in time and cost because the work to manufacture the dedicated lead cone is required each time. In addition, when manufacturing the dedicated lead cone, information on the weight and shape of the test specimen 30 is important, but since the design of the weapon system under development often undergoes changes before entering the test, there is a problem in that it is difficult to perform the test by manufacturing the dedicated lead cone suitable for the test specimen 30. Accordingly, when a method of stacking the adjustment plate 120 on the lead cone 110 is used, as illustrated in the present disclosure, there is an effect of saving time and cost by not having to manufacture a mold for manufacturing the dedicated lead cone considering the shape and weight of the test specimen 30, and even if changes in the weight and shape of the test specimen 30 occur, the sawtooth shock duration may be adjusted by the adjustment plate 120 at the test site, thereby increasing the efficiency of the test.

The base 10 may be a seismic base. The lead cone assembly 100 may be disposed on the base 10, and the test table 20 may be dropped onto the base 10.

The test table 20 may be disposed above the base 10 at a distance from the base 10 and dropped onto the base 10. The test table 20 may be dropped onto the base 10 without the test specimen 30 in the preliminary test and may be dropped onto the base 10 together with the test specimen 30 in the present experiment.

The test specimen 30 may be disposed on the test table 20. The shape and weight of the test specimen 30 may be determined according to the characteristics of the weapon system under development.

The lead cone assembly 100 may include the lead cone 110 and the adjustment plate 120. The efficiency of the test may be increased by adjusting the sawtooth shock duration through the adjustment plate 120 stacked under the lead cone 110.

The lead cone 110 may have an upper portion in a cone shape, so a sawtooth shock wave may be generated when the test table 20 collides with the lead cone 110. As illustrated in FIG. 2B, a lead cone groove 110a may be formed in a lower surface of the lead cone 110. Here, the lead cone groove 110a may extend along the circumferential direction of the lower surface of the lead cone 110 so as to be coupled to the adjustment plate 120 without distortion along the central axis. Furthermore, it is only an embodiment that the lead cone groove 110a extends along the circumferential direction, and it is obvious that the lead cone groove 110a may have a different shape.

The adjustment plate 120 may be disposed between the lead cone 110 and the base 10. As illustrated in FIG. 2C, a protruding element 120b may be formed in an upper surface of the adjustment plate 120, so the lead cone 110 and the adjustment plate 120 may be connected to one another by the coupling of the lead cone groove 110a of the lead cone 110 and the protruding element 120b. In addition, as described below, the adjustment plate 120 may be formed in plurality, and as illustrated in FIG. 2D, a groove 120a may be formed in a lower surface of the adjustment plate 120, so the plurality of adjustment plates 120 may be connected to one another by the coupling of the groove 120a and the protruding element 120b of the adjustment plate 120. Here, the groove 120a and the protruding element 120b may extend along the circumferential directions of the upper surface and the lower surface of the adjustment plate 120, respectively, so as to be coupled to the lead cone 110 without distortion along the central axis. Furthermore, it is only an embodiment that the groove 120a and the protruding element 120b extend along the circumferential directions, and it is obvious that the groove 120a and the protruding element 120b may have different shapes.

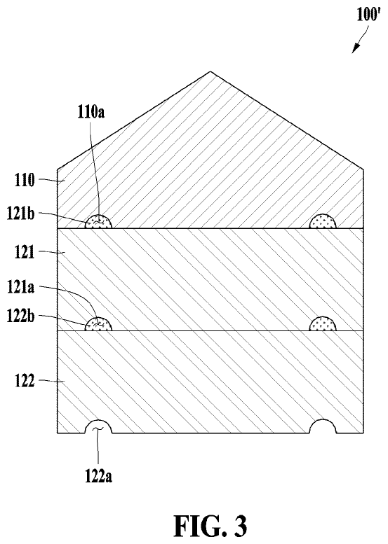

FIG. 3 schematically illustrates a side view of a lead cone assembly 100′ having a plurality of adjustment plates 121 and 122, according to an embodiment.

Referring to FIG. 3, the lead cone assembly 100′ according to an embodiment may include the plurality of adjustment plates 121 and 122. For example, a first adjustment plate 121 and a second adjustment plate 122 may be stacked on the lower portion of the lead cone 110. A protruding element 121b of the first adjustment plate 121 may be coupled to a lead cone groove 121a of the lead cone 110, and a protruding element 122b of the second adjustment plate 122 may be coupled to the lead cone groove 121a of the first adjustment plate 121 to be stacked.

Since the lead cone assembly 100′ includes the plurality of adjustment plates 121 and 122, the sawtooth shock duration may be effectively adjusted by stacking the plurality of adjustment plates 121 and 122.

Hereinafter, systems 200, 300, and 400 for monitoring and ensuring the safety of the impact test system 1 are described. Specifically, as described below, the systems 200, 300, and 400 for monitoring and ensuring the safety of the impact test system 1 may include the system 200 for measuring the number and positions of the lead cone assemblies 100, the system 300 for measuring a drop velocity of the test table 20, and the system 400 for preventing access by a tester.

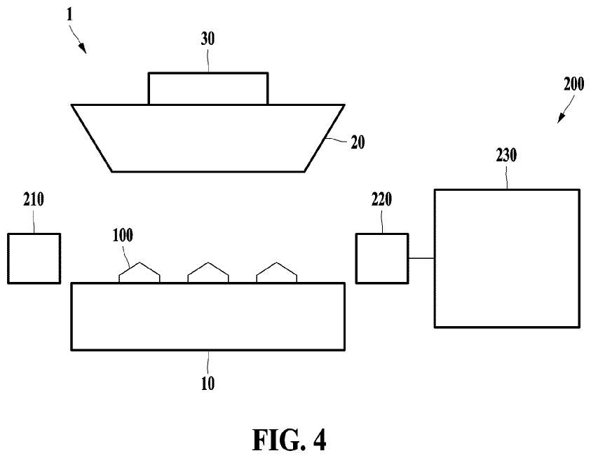

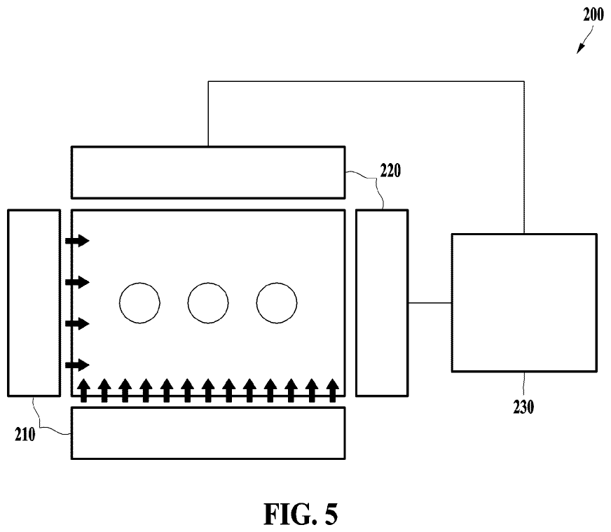

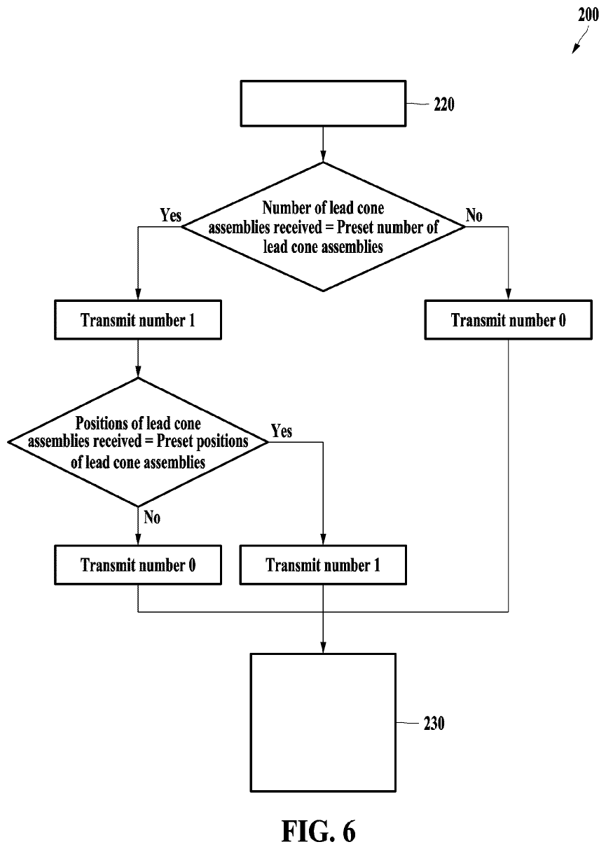

FIG. 4 schematically illustrates a side view of the system 200 for measuring the number and positions of the lead cone assemblies 100, according to an embodiment. FIG. 5 schematically illustrates a top view of the system 200 for measuring the number and positions of the lead cone assemblies 100, according to an embodiment. FIG. 6 schematically illustrates a signal transmission system of the system 200 for measuring the number and positions of the lead cone assemblies 100, according to an embodiment.

Referring to FIGS. 4 to 6, the system 200 for measuring the number and positions of the lead cone assemblies 100 of the impact test system 1, according to an embodiment, may include a laser generator 210 disposed on one side of the base 10 and configured to generate a laser, a laser receiver 220 disposed on the other side of the base 10 and configured to receive an output signal by the laser generated from the laser generator 210, and a controller 230 configured to receive information on the number and positions of the lead cone assemblies 100 from the laser receiver 220.

Specifically, in the first stage, the laser receiver 220 may measure whether the number of lead cone assemblies 100 is the same as the preset number of lead cone assemblies 100. When the number of lead cone assemblies 100 is different from the preset number of lead cone assemblies 100, the number 0 (abnormal signal) may be transmitted to the controller 230, and when the number of lead cone assemblies 100 is the same as the preset number of lead cone assemblies 100, the next stage may be executed.

In the second stage, the laser receiver 220 may measure whether the positions of the lead cone assemblies 100 are the same as the preset positions of the lead cone assemblies 100. When the positions of the lead cone assemblies 100 are different from the preset positions of the lead cone assemblies 100, the number 0 may be transmitted to the controller 230, and when the positions of the lead cone assemblies 100 are the same as the preset positions of the lead cone assemblies 100, the number 1 (normal signal) may be transmitted to the controller 230.

When the number and positions of the lead cone assemblies 100 are not appropriate, the controller 230 may prevent the impact test system 1 from operating, and thus, the test may be stably conducted.

The laser generator 210 may be disposed on one side of the base 10 and may generate a laser. For example, as illustrated in FIG. 5, the laser generator 210 may be provided in two laser generators, thereby generating a laser toward the lead cone assembly 100.

The laser receiver 220 may be disposed on the other side of the base 10 and may receive the output signal by the laser generated from the laser generator 210. For example, as illustrated in FIG. 5, the laser receiver 220 may be provided in two laser receivers, thereby receiving the output signal by the laser generated from the laser generator 210.

The controller 230 may operate the impact test system 1 by receiving the number 1 (normal signal) from the laser receiver 220 when the number and positions of the lead cone assemblies 100 are the same as the preset number and positions of the lead cone assemblies 100 and may stop the operation of the impact test system 1 by receiving the number 0 (abnormal signal) from the laser receiver 220 when at least one of the number and positions of the lead cone assemblies 100 is different from the preset number and positions of the lead cone assemblies 100.

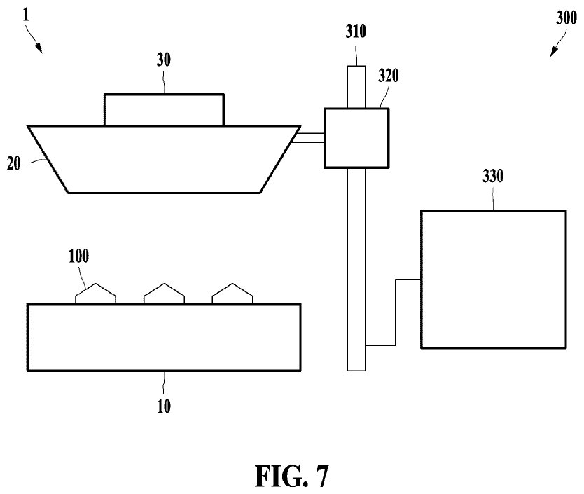

FIG. 7 illustrates a schematic diagram of the system 300 for measuring the drop velocity of the test table 20, according to an embodiment.

Referring to FIG. 7, the system 300 for measuring the drop velocity of the test table 20 of the impact test system 1, according to an embodiment, may include a position measurement sensor 310 configured to sense a position of the test table 20, a magnetic coil 320 connected to the test table 20 and surrounding the position measurement sensor 310, and a controller 330 configured to calculate a velocity at which the test table 20 collides with the lead cone assembly 100 from the position measurement sensor 310. Here, the position measurement sensor 310 may sense the position of the test table 20 by movement of the magnetic coil 320 surrounding the position measurement sensor 310.

Specifically, the position measurement sensor 310 may transmit information on the time and position to the controller 330 at regular intervals (e.g., at intervals of 0.2 mm of position variation) whenever the position of the test table 20 changes, and the controller 330 may calculate the velocity at which the test table 20 collides with the lead cone assembly 100 according to Equation 1 below.

$${V}_{Table} = \frac{{S}_{e} - {S}_{i}}{{T}_{e} - {T}_{i}} \qquad [ Equation 1 ]$$

In Equation 1, V_{Table} denotes the velocity at which the test table 20 collides with the lead cone assembly 100, Sₑ denotes the position in which the test table 20 starts to collide with the lead cone assembly 100, Sᵢ denotes the position immediately before the test table 20 starts to collide with the lead cone assembly 100, Tₑ denotes the time at which the test table 20 starts to collide with the lead cone assembly 100, and Tᵢ denotes the time immediately before the test table 20 starts to collide with the lead cone assembly 100.

That is, since accurately calculating the velocity of the dropping test table 20 plays an important role in the precision and safety of the test, a stable test may be performed by accurately calculating the impact velocity of the test table 20 through the system 300 for measuring the drop velocity of the test table 20.

The position measurement sensor 310 may sense the position of the test table 20. For example, the position measurement sensor 310 may correspond to a linear variable differential transformer (LVDT) that is an electrical transformer measuring a difference in a linear distance.

The magnetic coil 320 may be connected to the test table 20 and surround the position measurement sensor 310. As the magnetic coil 320 drops along the position measurement sensor 310 together with the test table 20, the position measurement sensor 310 may measure the position of the test table 20.

The controller 330 may be connected to the position measurement sensor 310 and calculate the velocity at which the test table 20 collides with the lead cone 110 according to Equation 1 described above.

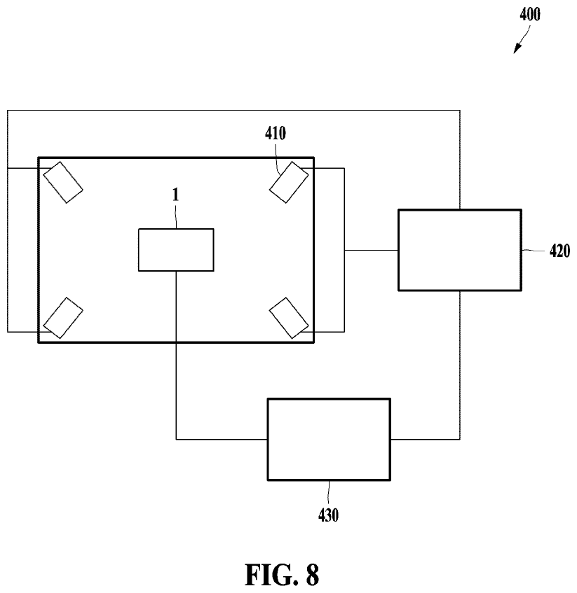

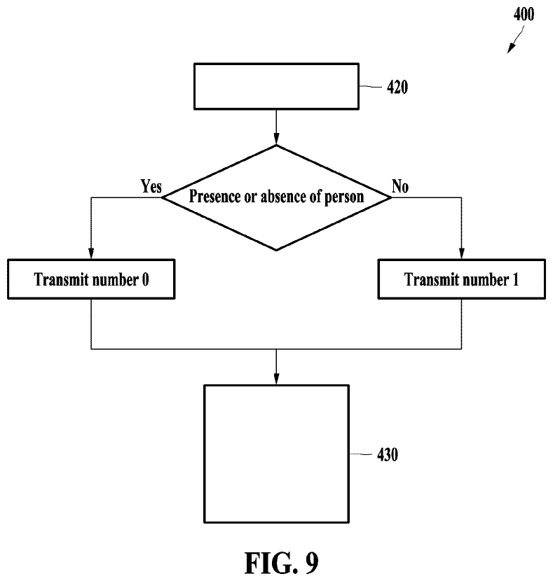

FIG. 8 illustrates a schematic diagram of the system 400 for preventing access by a tester, according to an embodiment. FIG. 9 illustrates a signal transmission system of the system 400 for preventing access by the tester, according to an embodiment.

Referring to FIGS. 8 and 9, the system 400 for preventing access by the tester to the impact test system 1, according to an embodiment, may include a camera 410 disposed around the impact test system 1 and configured to monitor the impact test system 1, an image reader 420 connected to the camera 410 and configured to read an image monitored by the camera 410, and a controller 430 configured to stop the operation of the impact test system 1 when the image reader 420 determines that the tester is present.

Specifically, as illustrated in FIG. 9, as a result of reading the presence of the tester from the image reader 420, when the tester is present, the number 0 (abnormal signal) may be transmitted to the controller 430, and when the tester is not present, the number 1 (normal signal) may be transmitted to the controller 430, so when the number 0 is received, the operation of the impact test system 1 may be stopped. Accordingly, accidents that may occur during a test may be prevented, thereby reducing or eliminating the risk of personal injury and damage to the impact test system 1.

The camera 410 may monitor the impact test system 1. The camera 410 may be disposed in plurality, for example, four cameras may be disposed, as illustrated in FIG. 8.

The image reader 420 may read the image monitored by the camera 410. For example, the image reader 420 may read the image using artificial intelligence (AI).

The controller 430 may stop the operation of the impact test system 1 when the number 0 is received from the image reader 420.

As described above, the impact test system 1 capable of adjusting the sawtooth shock duration, according to an embodiment, may stack the adjustment plate 120 on the lead cone 110 to eliminate the need to manufacture a dedicated lead cone considering the shape and weight of the test specimen 30, thereby saving time and cost, and may adjust the sawtooth shock duration by the adjustment plate 120 even when changes in the shape and weight of the test specimen 30 occur.

In addition, the systems 200, 300, and 400 for monitoring and ensuring the safety of the impact test system 1, according to an embodiment, may monitor the number and positions of the lead cone assemblies 100 of the impact test system 1, monitor the impact velocity of the test table 20, and prevent access by the tester to the impact test system 1.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. An impact test system capable of adjusting a sawtooth shock duration, the impact test system comprising:
a base;
a test table disposed above the base at a distance from the base and capable of being dropped toward the base;
a test specimen disposed on the test table; and
lead cone assemblies disposed on the base,
wherein the lead cone assemblies comprise:
a lead cone in a cone shape; and
an adjustment plate disposed between the lead cone and the base, wherein a sawtooth shock wave is generated when the test table collides with the lead cone due to a drop of the test table, and wherein a sawtooth shock duration is adjusted by adjusting heights of the lead cone assemblies according to the adjustment plate.

2. The impact test system of claim 1, wherein a lead cone groove is formed in a lower surface of the lead cone, and a protruding element is formed in an upper surface of the adjustment plate, so the lead cone and the adjustment plate are connected to one another by coupling of the lead cone groove and the protruding element.

3. The impact test system of claim 2, wherein the adjustment plate is formed in plurality, and wherein a groove is formed in a lower surface of the adjustment plate, so the plurality of adjustment plates is connected to one another by coupling of the groove and the protruding element of the adjustment plate.

4. The impact test system of claim 3, wherein the lead cone groove of the lead cone extends along a circumferential direction of the lower surface of the lead cone, and the protruding element and the groove of the adjustment plate extend along circumferential directions of the upper surface and the lower surface of the adjustment plate, respectively.

5. A system for measuring a number and positions of the lead cone assemblies of the impact test system capable of adjusting the sawtooth shock duration according to claim 1, the system comprising:
a laser generator disposed on one side of the base and configured to generate a laser;
a laser receiver disposed on another side of the base and configured to receive an output signal by the laser generated from the laser generator; and
a controller configured to receive information on the number and the positions of the lead cone assemblies from the laser receiver.

6. The system of claim 5, wherein the laser receiver is configured to:
in a first stage, measure whether the number of the lead cone assemblies is the same as a preset number of lead cone assemblies, and
in a second stage, measure whether the positions of the lead cone assemblies are the same as preset positions of lead cone assemblies.

7. A system for measuring a drop velocity of the test table of the impact test system capable of adjusting the sawtooth shock duration according to claim 1, the system comprising:
a position measurement sensor configured to sense a position of the test table;
a magnetic coil connected to the test table and surrounding the position measurement sensor; and
a controller configured to calculate a velocity at which the test table collides with the lead cone from the position measurement sensor, wherein the position measurement sensor is configured to sense the position of the test table by movement of the magnetic coil surrounding the position measurement sensor.

8. The system of claim 7, wherein the position measurement sensor corresponds to a linear variable differential transformer (LVDT).

9. A system for preventing access by a tester to the impact test system capable of adjusting the sawtooth shock duration according to claim 1, the system comprising:
a camera disposed around the impact test system and configured to monitor the impact test system;
an image reader connected to the camera and configured to read an image monitored by the camera; and
a controller configured to stop an operation of the impact test system when the image reader determines that the tester is present.

10. The system of claim 9, wherein the image reader is configured to read the image through artificial intelligence (AI).
